(19) United States
(12) Patent Application Publication
(10) Pub. No.: US 2025/0270847 A1
(43) Pub. Date: Aug. 28, 2025

(54) Security System for Locks

(71) Applicant: Salto Systems, S.L., Oiartzun (ES)

(72) Inventors: Carlos Ferreira Sánchez, Oiartzun (ES); Javier Lecaroz Amunarriz, Oiartzun (ES)

(21) Appl. No.: 18/856,270

(22) PCT Filed: Apr. 11, 2023
(86) PCT No.: PCT/ES2023/070229

§ 371 Date: Oct. 11, 2024

(30) Foreign Application Priority Data
Apr. 13, 2022 (ES) P202230339

(51) Int. Cl. E05B 17/20

(52) U.S. Cl. CPC E05B 17/2092

(57) ABSTRACT

A security system for bolt locks provided with a closed-door detector, an anti-tamper cam and a hinged locking element with a second axis of articulation and which is provided with a bolt locking portion.

### CROSS-REFERENCE TO RELATED APPLICATIONS

This application is the United States national phase of International Application No. PCT/ES2023/070229, filed Apr. 11, 2023, and claims priority to Spanish Patent Application No. P202230339, filed Apr. 13, 2022, the disclosures of which are hereby incorporated by reference in their entirety.

### BACKGROUND OF THE INVENTION

### Field of the Invention

The present disclosure belongs to the technical field of locks.

More specifically, this disclosure relates to a security system to be used in locks equipped with a bolt and, as the name suggests, is intended to enhance the security of said security system, comprising an anti-tamper cam and a closed-door detector.

### Description of Related Art

There are two main barriers that prevent unauthorised access to the interior of a closed space: the access door and the lock that locks said door.

In general, the degree of security of doors depends on two main factors: the design and the materials used to build them. This has allowed several different types of doors to be developed based on the desired degree of safety, which varies from normal doors to armoured and ironclad doors.

However, reinforcing a door is not effective without having a lock that provides enough resistance against possible attacks.

Currently, lock manufacturers and designers are trying to implement security systems that provide protection against new techniques of unauthorised lock tampering.

One of the main difficulties of implementing new security systems for locks is that said systems must be able to distinguish between a normal use of the lock and an undesirable tampering, so that said security system is only activated when the lock is subjected to an attack.

Moreover, security systems must be sufficiently compact in size to allow for the installation thereof in the space available inside the lock, which is usually quite small.

The locks of interest in the present disclosure are provided with a bolt. The bolt is a wedge-shaped element that is introduced in a hole provided in the doorframe to keep the door closed.

One disadvantage of these types of locks is that they can be easily opened by inserting a plastic card or other object in the form of a sheet or plate, such as a radiograph, in the gap between the door and the doorframe, thereby extracting the bolt from the hole in the doorframe.

Different security systems comprising a closed-door detector and an anti-tamper cam (also called anti-card element) have been developed to prevent this. Said anti-tamper cam is configured so that in a first non-locking position it does not actively intervene, while in a second locking position, when the door is closed, it acts as a stop, preventing the bolt of the lock from being moved in an unauthorised tampering attempt (such as pushing the bolt with a plastic card).

However, the previously described security system could be tampered with and unauthorised access could be achieved even if the anti-tamper cam is in said second locking position. In fact, if sufficiently intense vibrations are applied to the lock, the anti-tamper cam can be moved, and thus the bolt could be momentarily unlocked and tampered with in an unauthorised fashion, such as by pushing it with a plastic card or similar element.

In light of this, there is a need in the sector to develop novel security systems for locks to make them difficult to tamper with.

### SUMMARY OF THE INVENTION

The present disclosure aims to solve the previously expressed problems, disadvantages and drawbacks of the aforementioned security systems in locks of the state of the art.

To do so, a first object of the disclosure relates to a security system for locks, said locks being equipped with a bolt, wherein the security system comprises:
a closed-door detector configured to move linearly when actuated by an external element, and
an anti-tamper cam configured to be situated either in a first non-locking position or in a second locking position, such that said anti-tamper cam is situated in a second locking position when the closed-door detector moves linearly by making contact with the external element, preventing the bolt from opening and keeping the lock locked when being tampered with.

The bolt of the present lock is loaded by means of a spring, which allows it to keep its position while providing resistance to the movement of said bolt.

In a particular embodiment, the external element that actuates the closed-door detector is the doorframe and/or the strike.

The closed-door detector is configured to detect if the door is closed, moving linearly and, in turn, moving the anti-tamper cam to the second locking position thereof, which allows the lock to be kept in the closed position thereof, keeping the bolt in the housing of the same in the doorframe.

The security system object of the present disclosure prevents the bolt from being unlocked when ill-intentioned vibrations are produced that are able to momentarily move the anti-tamper cam to a first non-locking position, in which the anti-tamper cam does not prevent the opening of the bolt.

Likewise, the security system comprises a hinged locking element configured to rotate around a second axis of articulation, the hinged locking element being provided with a locking portion configured in such a way so that when the hinged locking element rotates around the second axis of articulation, said locking portion acts as a stop for the bolt, preventing the opening thereof.

Thanks to the specific configuration of the previously described hinged locking element, the moment the lock receives a vibration with an intensity that exceeds a predefined threshold, said vibration makes the anti-tamper cam move momentarily to the first non-locking position and, at the same time, said vibration makes the hinged locking element rotate around the second axis of articulation, such that the locking portion acts as a stop for the bolt, preventing it from opening (meaning, preventing the bolt from coming out of the hole provided in the doorframe).

In a particular embodiment, the anti-tamper cam is configured to rotate around a first axis of articulation.

In a particular embodiment, the hinged locking element is sized so that it meets the following geometric condition:

$$H \times {L}_{2} > R \times {L}_{1}$$

wherein:
(H) is the distance along which the anti-tamper cam locks the bolt;
(R) is the distance the hinged locking element must travel to lock the bolt;
(L1) is the distance between the first axis of articulation and the first point of contact between the anti-tamper cam and the bolt; and
(L2) is the distance between the second axis of articulation and the first point of contact between the locking portion and the bolt.

In order for the system to function in an optimal way, the distance (R) the hinged locking element must travel to be able to lock the bolt must be greater than zero (meaning, R>0), since, if this is not the case, the locking portion of the hinged locking element will lock the bolt even when there are no vibrations, which is not desirable.

In cases where the lock is tampered with by using sufficiently intense vibrations on the same, the anti-tamper cam and the hinged locking element will move. The difference in mass of both pieces is negligible in comparison with the force applied during said vibrations, and thus both parts rotate at the same angular speed according to angle a around the first and second axis of articulation, respectively.

In light of the foregoing points, and in order for the security system of the disclosure to function correctly, the hinged locking element must begin to lock the bolt before the anti-tamper cam ceases to lock it. This condition is represented by the following formula:

$$1 - ( \frac{d H}{H} ) > 1 - ( \frac{d R}{R} )$$

Using the angle a, we define the movements dH and dR as:

$$d R = {L}_{2} \times d α$$

$$dH = {L}_{1} \times d α$$

Introducing the previous two formulas into the first one, and clearing the data, the following expression is deduced:

$$H \times {L}_{2} > R \times {L}_{1}$$

This formula implies that the greater the distance in which the anti-tamper cam locks the bolt (H), the better the security system functions. Likewise, the smaller the range of movement of the hinged locking element (R), the better the security system functions, and lastly, the smaller the difference between L1 and L2, even if L2 is greater than L1, if allowed for by the design, the better the security system functions.

To provide a greater margin for proper operation and considering that the hinged locking element must act once the anti-tamper cam is no longer in the second locking position, in addition to the previous conditions, the system of the disclosure also preferably complies with the following geometric condition:

A>B

wherein:
(A) is the distance the bolt travels until it is locked by the hinged locking element; and
(B) is the distance the bolt travels until it is locked by the anti-tamper cam.

Furthermore, it is also preferable that the anti-tamper cam begin to lock the bolt before the bolt travels distance A, thereby preventing the locking thereof by the hinged locking element. This condition is represented by the following formula:

$$1 - ( \frac{d A}{A} ) > 1 - ( \frac{d R}{R} )$$

Lastly, combining the previous equations, the equations of movements, and clearing the known data, the following conclusion is reached:

$$A \times L 2 \times d α > R \times dA$$

Moreover, in order for the anti-tamper cam to function correctly, the movement of the anti-tamper cam (H) must be greater than the movement of the bolt (B) for the lock to work properly (this condition is intrinsic in the configuration of the anti-tamper cam).

$$1 - ( \frac{d B}{B} ) > 1 - ( \frac{dH}{H} )$$

Lastly, combining the previous equations, the equations of movements, and clearing the known data, the following inequality is reached:

$$B \times L 1 \times d α > H \times dB$$

Given that the movement of the bolt is the same, both in the case of the movement in the anti-tamper cam and movement in the hinged locking element, the expression dA=dB is reached. In turn, by combining this last equation with the ones previously obtained, it is also concluded that in a preferred embodiment of the system of the disclosure, the following geometric condition is met:

$$A \times H \times L 2 > R \times B \times L 1$$

The previous formula implies that the greater A, H or L2, the better the security system of the disclosure functions. Likewise, the smaller R or L1, the better said system functions, always provided that R>0, so as to prevent the bolt from being continuously locked.

In a preferred embodiment of the disclosure, the centre of mass of the hinged locking element (in other words, the geometric point that dynamically behaves as if the resulting external forces that act on said hinged element were applied to the same) is misaligned with respect to the second axis of rotation. In other words, in said preferred embodiment of the disclosure, the centre of gravity of the hinged locking element is situated outside of the second axis of rotation. This condition allows the hinged locking element to move to a greater extent due to the effect of the external shocks applied to the system.

In an embodiment of the system of the disclosure, the hinged locking element is situated in a position in which, due to gravity, it can modify its position and lock the bolt in a permanent way. In this embodiment, the security system further comprises a spring that allows the hinged locking element to be kept in the position thereof, meaning it keeps the hinged locking element spring-loaded. In said specific embodiment of the disclosure the mass of said hinged locking element is greater than in the case of hinged locking elements lacking said additional spring so that said hinged locking element is able to compensate for the elastic force of said spring the moment a sufficiently intense vibration or impact occurs to ensure that the functioning of the hinged locking element is correct.

A second object of the disclosure relates to a lock equipped with a bolt, which is provided with a security system according to the first aspect of the disclosure.

### BRIEF DESCRIPTION OF THE DRAWINGS

The terms Fig., Figs., Figure, and Figures are used interchangeably in the specification to refer to the corresponding figures in the drawings.

What follows is a set of drawings with very brief descriptions to help the disclosure be further understood, drawings that are expressly related to an embodiment of said disclosure and provide non-limiting examples of the same.

FIG. 1 is a transverse cross-sectional view of a security system for locks according to the present disclosure, wherein the anti-tamper cam is in the first non-locking position;

FIG. 2 is a transverse cross-sectional view of the security system of FIG. 1, wherein the anti-tamper cam is in the second locking position; and

FIG. 3 is a cross-sectional view of the security system of FIG. 1, wherein after a sufficiently intense vibration the hinged locking element of the bolt has been activated.

### NUMERICAL REFERENCES OF THE DRAWINGS

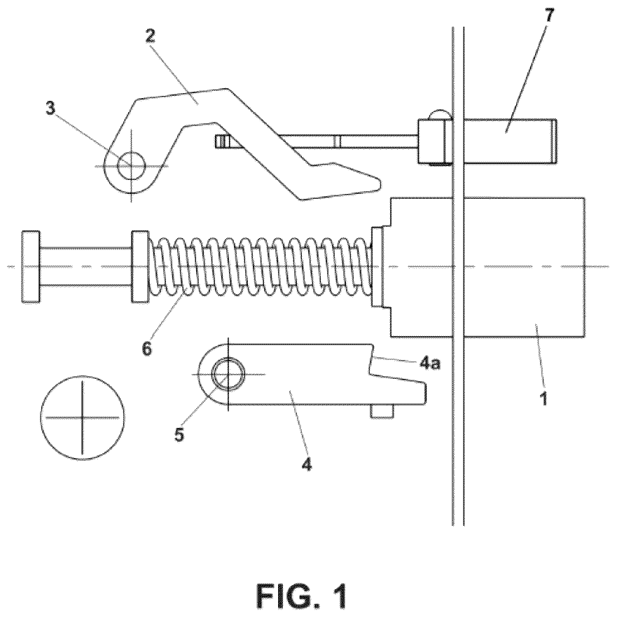

(1) Bolt (of the lock);
(2) Anti-tamper cam;
(3) First axis of articulation;
(4) Hinged locking element;
(4a) Locking portion (of the hinged locking element)
(5) Second axis of articulation;
(6) Spring to load the bolt;
(7) Closed-door detector
(H) Vertical distance, according to the orientation of FIGS. 1-3, in which the anti-tamper cam locks the bolt;
(R) Vertical distance, according to the orientation of FIGS. 1-3, the hinged locking element must travel to lock the bolt;
(L1) Distance between the first axis of articulation and the first point of contact between the anti-tamper cam and the bolt;
(L2) Distance between the second axis of articulation and the first point of contact between the locking portion and the bolt;
(a) angle of rotation of the anti-tamper cam and of the hinged locking element around the first and second axis of articulation, respectively;
(A) Horizontal distance, according to the orientation of FIGS. 1-3, the bolt travels until being locked by the hinged locking element;
(B) Horizontal distance, according to the orientation of FIGS. 1-3, the bolt travels until being locked by the anti-tamper cam, and
(M) Doorframe.

### DESCRIPTION OF THE INVENTION

FIG. 1 shows an embodiment of a security system for locks according to the present disclosure.

Said lock is provided with a bolt (1) loaded by a spring (6) which provides a resistance to the movement of said bolt (1), such that said bolt (1) is inserted in a hole provided in the doorframe, keeping the door locked.

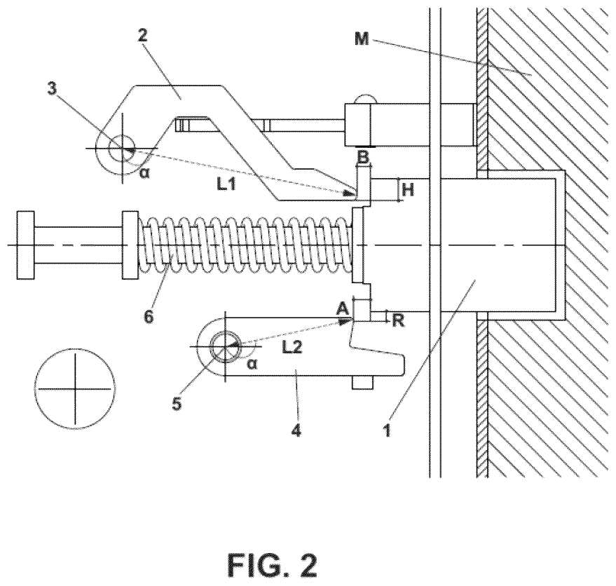

The security system according to the disclosure comprises a closed-door detector (7) and an anti-tamper cam (2) configured to rotate around a first axis (3) of articulation when the closed-door detector (7) is linearly moved by being pushed by the doorframe (M) or by the lock when closing the door, until the anti-tamper cam (2) is situated in a second locking position, thereby preventing the bolt (1) from opening by means of contact between said anti-tamper cam (2) and the bolt (1), shown in FIG. 2.

The configuration shown in FIG. 1 corresponds to the case in which the anti-tamper cam (2) is in a first non-locking position. In fact, as can be seen in this figure, the bolt (1) can freely move to the left along the main axis or longitudinal axis thereof according to the orientation of FIG. 1, the same being an axis that is horizontally arranged, without coming into contact at any point with the anti-tamper cam (2).

The security system according to the disclosure is also equipped with hinged locking element (4) provided with a second axis (5) of articulation.

The hinged locking element (4) comprises a locking portion (4a) intended to act as a stop for the bolt (1), preventing it from coming out of the hole provided in the doorframe (M).

In the case shown in FIG. 1, the hinged locking element (4) is also in the first non-locking position thereof, wherein the upper end of the locking portion (4a) is below the lower edge of the bolt (1). Thus, the bolt (1) can also move freely to the left along the main axis or longitudinal axis thereof according to the orientation of FIG. 1, the same being a horizontal axis, without coming into contact at any point with the hinged locking element (4).

FIG. 2 shows the security system of FIG. 1 in a configuration in which the anti-tamper cam (2) is in the second locking position thereof, meaning, the closed-door detector (7) has been linearly moved by being pushed by the doorframe (M) when the door closes. As the closed-door detector (7) moves, it makes the anti-tamper cam (2) rotate, moving it vertically downwards (according to the orientation of FIGS. 1 and 2) and into a distance (H), such that if the bolt (1) travels a horizontal distance (B) to the left along the main axis thereof, it will come into contact with the anti-tamper cam (2) which will act as a stop, preventing the same from continuing to move. Since the horizontal distance (B) is not enough for the bolt to come out of the hole provided in the frame, the door will remain closed and will not be able to be opened.

FIG. 2 also shows the geometric distances L1 (distance between the first axis (3) of articulation and the first point of contact of the anti-tamper cam (2) and the bolt) and L2 (distance between the second axis (5) of articulation and the first point of contact of the locking portion (4a) and the bolt), as well as distances (A) and (R), which will be described in greater detail below.

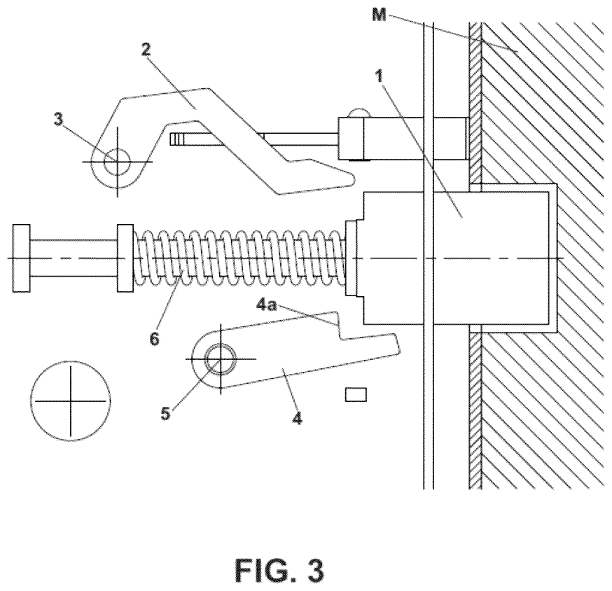

Lastly, FIG. 3 shows the security system of FIG. 2 when a vibration has occurred that is sufficiently intense to move the anti-tamper cam (2) and activate the hinged locking element (4). In this case, the vibration causes the anti-tamper cam (2) to be momentarily situated in the first non-locking position thereof, making the lock vulnerable, and, at the same time, the vibration causes the hinged locking element (4) to activate and rotate around the second axis (5) of articulation an angle (a) until being momentarily situated in the second locking position thereof, thereby eliminating the vulnerability of the lock. The rotation of the hinged locking element (4) around the second axis (5) causes the locking portion (4a) to be move vertically upwards a distance (R), according to the orientation of FIGS. 1-3. In this configuration, if the bolt (1) travels a horizontal distance (A) to the left along the main axis thereof, it will come into contact with the locking portion (4a), which will act as a stop, preventing the same from continuing to move. Since the horizontal distance (A) is not enough for the bolt to come out of the hole provided in the frame, the door will remain closed and will not be able to be opened.

The disclosure should not be limited to the particular embodiment described herein. People skilled in the art may develop other embodiments in light of the description provided herein. Accordingly, the scope of the disclosure is defined by the following claims.

1. A security system for locks, said locks being equipped with a bolt, wherein the security system comprises:
a closed-door detector configured to move linearly when activated by an external element, and
an anti-tamper cam configured to be situated either in a first non-locking position or in a second locking position, such that said anti-tamper cam is situated in a second locking position when the closed-door detector moves linearly by making contact with the external element, preventing the bolt from opening;
wherein said security system further comprises a hinged locking element configured to rotate around a second axis of articulation, the hinged locking element being provided with a locking portion configured in such a way that when the hinged locking element rotates around the second axis of articulation, said locking portion acts as a stop for the bolt, preventing the opening thereof.

2. The security system for locks according to the claim 1, wherein the anti-tamper cam is configured to rotate around a first axis of articulation.

3. The security system for locks according to claim 1, wherein the hinged locking element is dimensioned to comply with the following geometric condition:
$$H \times {L}_{2} > R \times {L}_{1}$$
wherein:
(H) is the distance within which the anti-tamper cam locks the bolt;
(R) is the distance that the hinged locking element must travel to lock the bolt;
(L1) is the distance between the first axis of articulation and the first point of contact of the anti-tamper cam and the bolt; and
(L2) is the distance between the second axis of articulation and the first point of contact of the locking portion and the bolt.

4. The security system for locks according to claim 1, wherein the following geometric condition is also met:
A>B
wherein:
(A) is the distance the bolt travels until it is locked by the hinged locking element; and
(B) is the distance the bolt travels until it is locked by the anti-tamper cam.

5. The security system for locks according to the claim 3, wherein the following geometric condition is also met:
$$A \times H \times L 2 > R \times B \times L 1.$$

6. The security system for locks according to claim 1, wherein the centre of gravity of the hinged locking element is situated outside the second axis of rotation.

7. The security system for locks according to claim 1, wherein the hinged locking element is spring-loaded.

8. A lock, equipped with a bolt and further provided with a security system according to claim 1.
